(19) United States
(12) Patent Application Publication
(10) Pub. No.: US 2026/0346162 A1
(43) Pub. Date: Nov. 5, 2026

(54) IODINE RECOVERY METHOD AND APPARATUS

(71) Applicants: SK ON CO., LTD., Seoul (KR); SK Innovation Co., Ltd., Seoul (KR)

(72) Inventors: Jae Hun JEONG, Daejeon (KR); Soo Kil KANG, Daejeon (KR); Hee Du LEE, Daejeon (KR)

(21) Appl. No.: 19/633,886

(22) Filed: Mar. 30, 2026

(30) Foreign Application Priority Data
Apr. 30, 2025 (KR) 10-2025-0057719
Nov. 14, 2025 (KR) 10-2025-0172258

(51) Int. Cl. B01D 11/04; C01B 7/14

(52) U.S. Cl. CPC B01D 11/0492; B01D 11/0488; C01B 7/14

(57) ABSTRACT

A disclosed iodine recovery apparatus may include: a main chamber configured to bring gaseous iodine into contact with a main solvent so that the gaseous iodine is cooled and precipitated; an upper spray unit disposed in an upper portion of the main chamber and the upper spray unit being connected to receive the main solvent, the upper spray unit having spray holes configured to spray the main solvent downward from the upper portion; an inlet pipe positioned below the upper spray unit and connected to the main chamber, the inlet pipe is configured to introduce the gaseous iodine into the main chamber; and a separation chamber configured to receive iodine precipitated in the main chamber and the main solvent from the main chamber. The separation chamber is configured to separate the precipitated iodine and the main solvent. Also disclosed is an iodine recovery method.

### CROSS-REFERENCE TO RELATED APPLICATION

This patent application claims the priority and benefits of Korean patent application No. 10-2025-0057719, filed on Apr. 30, 2025 and Korean patent application No. 10-2025-0172258, filed on Nov. 14, 2025, the disclosure of which is incorporated herein by reference in its entirety.

### BACKGROUND OF THE INVENTION

### 1. Field of the Invention

The present disclosure relates to an iodine recovery method and an iodine recovery apparatus.

### 2. DESCRIPTION OF THE RELATED ART

Iodine is a high-value substance used in various chemical processes. Research is being conducted on techniques for recovering iodine from a mixed gas generated after a reaction.

Typically, to recover iodine from a mixed gas, a method of precipitating (desublimating) iodine into a solid state through cooling is used.

In such a method, precipitated iodine may adhere to inner walls of an apparatus, which may result in pipe clogging, reduced heat transfer, and process interruptions. In particular, if solid iodine accumulates beyond a certain thickness, the above-described problems may be exacerbated, thereby making continuous process operation difficult.

### SUMMARY OF THE INVENTION

An object of the present disclosure is to provide an apparatus and a method for separating and recovering iodine from a gas mixture.

An iodine recovery apparatus according to embodiments of the present disclosure may include: a main chamber configured to bring gaseous iodine into contact with a main solvent so that the gaseous iodine is cooled and precipitated; an upper spray unit disposed in an upper portion of the main chamber, the upper spray unit being connected to receive the main solvent, the upper spray unit having spray holes configured to spray the main solvent downward from the upper portion; an inlet pipe positioned below the upper spray unit and connected to the main chamber, the inlet pipe is configured to introduce the gaseous iodine into the main chamber; and a separation chamber configured to receive the iodine precipitated in the main chamber and the main solvent from the main chamber, the separation chamber being further configured to separate the precipitated iodine and the main solvent.

In embodiments, the iodine recovery apparatus may further include a dispersion plate disposed within the main chamber, the dispersion plate being configured to disperse the gaseous iodine.

In embodiments, the iodine recovery apparatus may further include at least one tray disposed below the upper spray unit, the at least one tray being configured to guide movement of the main solvent and the precipitated iodine.

In embodiments, the at least one tray may be inclined downward toward the separation chamber.

In embodiments, a plurality of trays may be provided along a vertical direction of the main chamber.

In embodiments, the plurality of trays may be each connected to the separation chamber, the plurality of trays may be configured to transfer the main solvent and the precipitated iodine on each of the plurality of trays to the separation chamber.

In embodiments, the at least one tray may have through holes configured to allow passage of the gaseous iodine or the precipitated iodine therethrough.

In embodiments, the tray may be coated with any one of a polytetrafluoroethylene (PTFE) film, a polyethylene terephthalate (PET) film, and a tetrafluoroethylene-perfluoroalkyl vinyl ether copolymer (PFA) film.

In embodiments, the iodine recovery apparatus may be further configured to separate the precipitated iodine from the main solvent.

In embodiments, a filter may be disposed in the separation chamber, the filter being configured to allow the main solvent to pass therethrough and prevent the precipitated iodine from passing therethrough.

In embodiments, the apparatus may include a heat treatment unit in the separation chamber configured to heat the precipitated iodine and the main solvent, thereby separating the precipitated iodine and the main solvent.

In embodiments, the heat treatment unit may be configured to distill the main solvent in the separation chamber to separate the main solvent from the precipitated iodine.

In embodiments, the heat treatment unit may be configured to heat the main solvent and the precipitated iodine in the separation chamber such that the precipitated iodine is converted into liquid iodine. In addition, the separation chamber may include a liquid-liquid separator configured to receive the main solvent and the liquid iodine and subject the main solvent and the liquid iodine to liquid-liquid separation, thereby recovering the liquid iodine.

In embodiments, the iodine recovery apparatus may further include a circulation pipe connected to the main chamber and the separation chamber. The circulation pipe may be configured to supply the main solvent separated from the precipitated iodine in the separation chamber to the main chamber.

In embodiments, the iodine recovery apparatus may further include a cooler connected to the circulation pipe and configured to cool the main solvent supplied to the main chamber.

In embodiments, the iodine recovery apparatus may further include a lower spray unit extending from the upper spray unit. The lower spray unit being disposed at a lower portion of the main chamber, and configured to spray the main solvent toward the separation chamber.

An iodine recovery method according to embodiments of the present disclosure may include: spraying a main solvent downward from an upper spray unit disposed in an upper portion of a main chamber; introducing gaseous iodine into the main chamber; cooling the gaseous iodine upon contact with the main solvent in the main chamber to precipitate the iodine; separating the precipitated iodine from the main solvent.

In embodiments, the main chamber may include a tray configured to guide movement of the main solvent and the precipitated iodine as part of the introducing the precipitated iodine and the main solvent into a separation chamber.

In embodiments, the iodine recovery method may further include supplying the main solvent separated in a separation chamber to the main chamber.

In embodiments, the supplying the main solvent separated in the separation chamber to the main chamber, may further include cooling the main solvent separated in the separation chamber before supplying that main solvent to the main chamber.

According to an embodiment of the present disclosure, a low-temperature solution may be sprayed into a gas mixture such that gaseous iodine included in the gas mixture is precipitated. Accordingly, the amount of iodine discharged without being recovered may be reduced, thereby increasing the iodine recovery rate.

In addition, according to an embodiment of the present disclosure, liquid or solid iodine may be discharged together with the solution, thereby preventing accumulation within the main chamber. Accordingly, a continuous process may be enabled and maintenance may be facilitated. Furthermore, the inlet pipe through which the gas mixture is introduced may be prevented from becoming clogged or from experiencing a reduction in heat transfer efficiency.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a conceptual diagram of an iodine recovery apparatus according to an embodiment of the present disclosure;

FIG. 2 is a plan view of a dispersion plate shown in FIG. 1.

FIG. 3 is a cross-sectional view taken along line A1-A2 of FIG. 2;

FIG. 4 is a conceptual diagram of an iodine recovery apparatus according to another embodiment of the present disclosure;

FIG. 5 is a block diagram illustrating connection relationships between some components constituting the iodine recovery apparatus according to an embodiment of the present disclosure;

FIG. 6 is a flowchart illustrating an operating sequence of each component of the iodine recovery apparatus according to an embodiment of the present disclosure; and

FIGS. 7 and 8 are flowcharts illustrating an iodine recovery method according to an embodiment of the present disclosure.

### DETAILED DESCRIPTION OF THE INVENTION

The embodiments of the present disclosure are provided to more fully describe the present disclosure to those skilled in the art to which the present invention pertains. The following embodiments may be modified in various forms, and the scope of the present disclosure is not limited to these embodiments.

Hereinafter, some embodiments of the present disclosure will be described through exemplary drawings for the convenience of description. When assigning reference numerals to components of the respective drawings, it should be noted that the same components will be denoted by the same reference numerals, even if they appear in different drawings.

The terms or words used in this specification and the claims should not be construed as being limited to their conventional or lexical meanings, and instead, in accordance with the principle that an inventor may define the concepts of terms or words in the most appropriate manner to describe the invention, they should be interpreted based on the meanings and concepts that meet the technical spirit of the present disclosure.

The terms used herein are provided to describe specific embodiments and are not intended to limit the present disclosure. As used herein, the singular form may include the plural form unless the context clearly dictates otherwise.

In addition, when used to describe and define the present disclosure, terms such as “comprise,” “include,” “have”, and the like should be interpreted in a non-exclusive manner. Unless explicitly stated otherwise, these terms should be construed to imply that the presence of the corresponding component, and not to exclude but rather include other components.

In addition, in describing components of the embodiment of the present disclosure, the terms such as first, second, A, B, (a), (b), and the like may be used. These terms are used to distinguish the component from other components and do not impose any limitations on their nature, sequence or order, etc.

It will be understood that when a component is described as being “connected” or “coupled” (or the like) to another component, the component may be directly connected or coupled to the other component, but it may be “connected” or “coupled” to the other component with another component possibly interposed.

Space-related terms such as “beneath,” “below,” “lower,” “above,” “upper,” and the like may be used to aid in the understanding of the relationship between an element or feature and another illustrated in the drawings. These space-related terms are provided to aid in the understanding of the present disclosure in various processing or usage states and are not intended to impose any limitations on the present disclosure. For example, if an element or feature in the drawing is turned upside down, the element or feature described as “beneath” or “below” becomes “above” or “upper.” Accordingly, the term “beneath” is a relative concept that may encompass “upper” as well as “below” depending on orientation.

The embodiments described in this specification and the configurations illustrated in the drawings merely represent the most preferred embodiments of the present disclosure but do not encompass all aspects of the technical spirit of the present disclosure. Thus, it should be understood that various modifications and equivalents may be implemented at the time of filing the present application. In addition, the publicly known functions and configurations that are deemed unnecessary for clarifying the essence of the present invention will not be described.

Hereinafter, an iodine recovery apparatus according to an embodiment of the present disclosure will be described in detail with reference to the accompanying drawings.

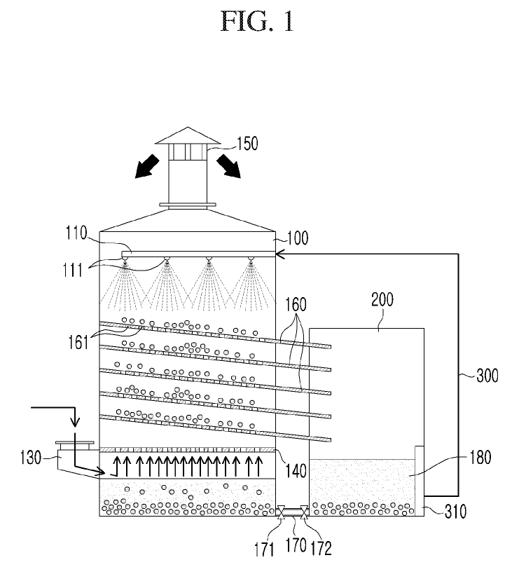

FIG. 1 is a conceptual diagram of the iodine recovery apparatus according to an embodiment of the present disclosure.

Referring to FIG. 1, the iodine recovery apparatus according to an embodiment of the present disclosure may include a main chamber 100 and a separation chamber 200.

An upper spray unit 110 may be disposed in an upper portion of the main chamber 100.

A main solvent may be supplied to the upper spray unit 110. The main solvent may be sprayed downward from the upper portion of the main chamber 100 through spray holes 111 formed through the upper spray unit 110.

The main solvent may be a liquid-phase substance.

For example, the main solvent may be a non-polar solvent. For example, the main solvent may be any one of toluene, benzene, hexane, ether, kerosene, or a mixture thereof.

The gas mixture may include a hydrogen halide, such as hydrogen fluoride (HF) or hydrogen iodide (HI). When the main solvent is a polar solvent, some components of the gas mixture may react with the main solvent or dissolve in the main solvent, thereby forming a highly corrosive solution. In this case, problems such as damage to the main chamber 100 may occur.

For example, the main solvent may include a polar solvent that does not react with, or has a weak reactivity with, hydrogen halides included in the gas mixture.. For example, the main solvent may include ethanol or chloroform.

For example, the main solvent may be a solution having a boiling point of 100° C or lower. As will be described in detail below, when distilling a discharge solution including the main solvent to recover the precipitated iodine, if the boiling point of the main solvent is high, high-temperature energy may be required during a distillation process.

The upper spray unit 110 may extend in one direction. Alternatively, the upper spray unit 110 may be formed in a shape corresponding to a cross-sectional shape of the main chamber 100. For example, if the main chamber 100 has a cylindrical shape, the upper spray unit 110 may have a circular shape, such as a disc.

Spray holes 111 may be formed in the upper spray unit 110. The main solvent may be sprayed downward from the upper portion of the main chamber 100 through the spray holes 111.

A plurality of spray holes 111 may be formed in the upper spray unit 110. For example, the spray holes 111 may be formed side by side in one direction. Alternatively, the spray holes 111 may be formed in a zigzag pattern. The arrangement of the plurality of spray holes 111 is not particularly limited as long as it allows the main solvent to be evenly sprayed into the main chamber 100.

An inlet pipe 130 through which gaseous iodine is introduced may be connected to the main chamber 100. Gaseous iodine may be introduced into the main chamber 100 through the inlet pipe 130. A gas mixture including gaseous iodine may be introduced into the main chamber 100 through the inlet pipe 130.

Hereinafter, a gas mixture including gaseous iodine will be described as being introduced into the main chamber 100. However, it will be understood that only gaseous iodine, rather than a gas mixture, may be introduced as an alternative.

The gas mixture may be introduced into the main chamber 100 through the inlet pipe 130.

For example, the gas mixture may be a reactor effluent.

For example, the gas mixture may include gaseous iodine and a non-condensable gas.

For example, the non-condensable gas may include halogenated hydrocarbons. The non-condensable gas, excluding iodine vapor, may have a boiling point of 50° C or lower.

For example, if the boiling point of the non-condensable gas is 50° C or higher, the non-condensable gas may be dissolved in a low-temperature solvent or act as an impurity, thereby reducing the iodine recovery rate. For example, when the non-condensable gas is liquefied or deposited as a solid, it may be difficult to separate the non-condensable gas from the solid iodine to be recovered.

For example, if the boiling point of the non-condensable gas is 50° C or lower, iodine may be selectively recovered from the substances contained in the gas mixture, thereby improving purity of the iodine.

The temperature of the gas mixture introduced into the main chamber 100 through the inlet pipe 130 may be 150° C to 250° C.

The gas mixture may be heated before being introduced into the inlet pipe 130 and then introduced into the inlet pipe 130. Alternatively, the inlet pipe 130 may be heated to increase the temperature of the gas mixture.

For example, the pressure within the main chamber 100 may be in a range of 1 atm to 3 atm. In this case, when the temperature of the gas mixture is 150° C to 250° C, the iodine included in the gas mixture introduced into the main chamber 100 may be present in a gaseous state.

The gas mixture may be introduced into the main chamber 100 through the inlet pipe 130.

The gas mixture may ascend after being introduced into the main chamber 100 and may come into contact with the main solvent.

For example, the temperature of the main solvent may be 50° C or lower.

A high-temperature gas mixture may come into contact with a main solvent having a temperature of 50° C or lower. The gas mixture and the main solvent in contact therewith may exchange heat. The gaseous iodine included in the gas mixture may be cooled by the main solvent and converted into solid iodine. At least a portion of the gaseous iodine may be precipitated as solid iodine.

The inlet pipe 130 may be positioned below the upper spray unit. For example, the inlet pipe 130 may be disposed below a center of the main chamber 100 in a vertical direction of the main chamber 100. The vertical direction of the main chamber 100 may be parallel to the direction of gravity.

When the inlet pipe 130 is disposed below the center of the main chamber 100, a path along which the gas mixture ascends may be increased. In the case of a gaseous mixture, contact time between the gas mixture and the main solvent may be increased. Alternatively, in the case of gaseous iodine, contact time between the gaseous iodine and the main solvent may be increased. Accordingly, the time during which the gaseous iodine contacts the main solvent and is precipitated may be increased.

A dispersion plate 140 may be installed in the main chamber 100.

The dispersion plate 140 may be installed above the inlet pipe 130. A gas mixture introduced into the main chamber 100 through the inlet pipe 130 may pass through the dispersion plate 140. The gas mixture may pass through the dispersion plate 140 and be dispersed within the main chamber 100.

The dispersion plate 140 may have a shape corresponding to the cross-sectional shape of the main chamber 100. For example, when the main chamber 100 has a cylindrical shape, the dispersion plate 140 may have a circular shape, such as a disc.

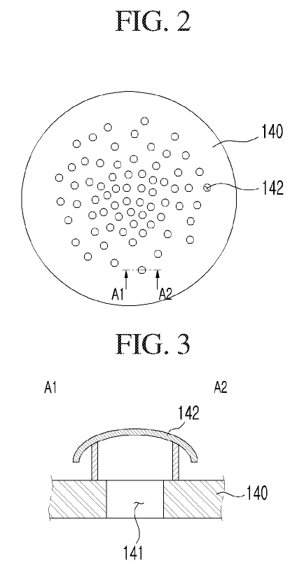

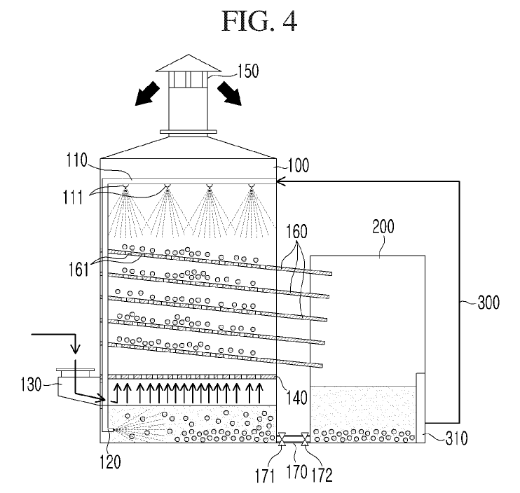

FIG. 2 is a plan view of the dispersion plate shown in FIGS. 1, and 3, is an enlarged cross-sectional view taken along line A-A of FIG. 2.

Referring to FIGS. 2 and 3, a plurality of dispersion holes 141 may be formed through the thickness of the dispersion plate 140.

The plurality of dispersion holes 141 may be arranged in a regular pattern in the dispersion plate 140. The plurality of dispersion holes 141 may also be arranged in an irregular pattern in the dispersion plate 140, as illustrated in FIG. 2. The arrangement pattern of the dispersion holes 141 is configured to disperse the gas mixture within the main chamber 100.

For example, the dispersion holes 141 may be densely formed in approximately a central portion in a longitudinal direction of the dispersion plate 140. A dispersion pattern of the gas mixture may be controlled according to the arrangement pattern of the dispersion holes 141. When the dispersion holes 141 are densely formed in the central portion of the dispersion plate 140, the gas mixture may be densely distributed in the central portion of the main chamber 100. The gas mixture may be distributed at a higher density toward the central portion than near a wall surface of the main chamber 100.

A cap member 142 may be disposed above the dispersion holes 141. The cap member 142 may be disposed above each dispersion hole 141. Alternatively, the cap member 142 may be disposed above some, but fewer than all, of the dispersion holes 141.

The cap member 142 may be disposed spaced apart from the dispersion holes 141. A spaced gap may be provided between the cap member 142 and the dispersion holes 141 in the vertical direction. The cap member 142 may be spaced apart from the dispersion plate 140. A spaced gap may be provided between the cap member 142 and the dispersion plate 140. Through a space between the cap member 142 and the dispersion plate 140, the gas mixture moving upward from a lower portion of the dispersion plate 140 through the dispersion holes 141 may be further dispersed throughout the main chamber 100.

The cap member 142 may have an upwardly convex shape. In this case, the main solvent sprayed downward from an upper portion may fall along the inclination of the cap member 142 toward the side of the dispersion hole 141. For example, the main solvent sprayed downward from the upper portion may fall onto the dispersion plate 140 rather than into the dispersion holes 141. Accordingly, the main solvent sprayed downward from the upper portion may be prevented from passing through the dispersion holes 141 and reaching a bottom surface of the main chamber 100. In this case, the contact time between the gas mixture and the main solvent may be increased, thereby improving the iodine recovery rate.

The gas mixture may be cooled upon contact with the main solvent falling within a space inside the main chamber 100. Gaseous iodine may be cooled upon contact with the main solvent and precipitated as solid iodine. When the gas mixture contacts the main solvent in the central portion of the main chamber 100, the gaseous iodine may be precipitated as solid iodine particles. Conversely, when the gaseous iodine comes into contact with the main solvent on the wall surface of the main chamber 100, the gaseous iodine may form crystals and grow on the wall surface of the main chamber 100. In this case, the internal volume of the main chamber 100 may decrease. The crystallized solid iodine may be fixed to the wall surface of the main chamber 100 and may be difficult to be transferred to the separation chamber 200.

A tray 160 may be installed in the main chamber 100.

The tray 160 may guide movement of the main solvent and the gas mixture. The main solvent and the gas mixture may be guided to be discharged from the main chamber 100 to the separation chamber 200.

For example, the tray 160 may have a flat plate shape. Alternatively, the tray 160 may include a flat plate member and a rim member extending upward from the flat plate member.

For example, the tray 160 may be installed so as to be inclined downward toward the separation chamber 200.

The main solvent sprayed from the upper portion of the main chamber 100 may remain on the tray 160. Iodine precipitated upon contact with the main solvent may remain on the tray 160. When the tray 160 is inclined downward, the main solvent may move along the inclined surface of the tray 160 by gravity. The precipitated iodine may be dispersed in the main solvent. The precipitated iodine may move together with the main solvent.

A plurality of trays 160 may be provided along the vertical direction of the main chamber 100. The number of trays 160 and spacing therebetween may vary depending on a volume or shape of the main chamber 100.

The respective trays 160 may be disposed parallel to each other. The main solvent and the precipitated iodine may remain on the respective trays 160. The main solvent and the precipitated iodine remaining on the respective trays 160 may move along the inclined surfaces of the trays 160. The precipitated iodine may be dispersed in the main solvent and moved by the main solvent.

The tray 160 may have through holes 161 through which the precipitated iodine may pass.

The gas mixture introduced into the main chamber 100 may pass through the through holes 161 and move upward. The main solvent sprayed from the upper portion of the main chamber 100 may pass through the through holes 161 and be sprayed toward a lower portion of the main chamber 100. When the gaseous iodine comes into contact with the main solvent and is precipitated, the precipitated iodine may remain on the respective trays 160. Alternatively, the precipitated iodine may pass through the through holes 161 and move to another of the trays 160 disposed below.

The tray 160 may be coated with a polymer film. The tray 160 may be coated with a material having low reactivity with iodine. The tray 160 may be coated with a material having low reactivity with the main solvent. For example, the tray 160 may be coated with one or more materials of a polytetrafluoroethylene (PTFE) film, a polyethylene terephthalate (PET) film, and a tetrafluoroethylene-perfluoroalkyl vinyl ether copolymer (PFA) film. The tray 160 may not react with the main solvent and iodine remaining on the tray 160 and may guide movement of the main solvent and the precipitated iodine.

The plurality of trays 160 may each protrude from the main chamber 100 toward the separation chamber 200. Alternatively, the plurality of trays 160 may each extend from the main chamber 100 toward the separation chamber 200. Alternatively, the plurality of trays 160 may each be connected to the separation chamber 200. The main solvent and the precipitated iodine remaining on each tray 160 may move along the respective tray 160 and be transferred from the main chamber 100 to the separation chamber 200.

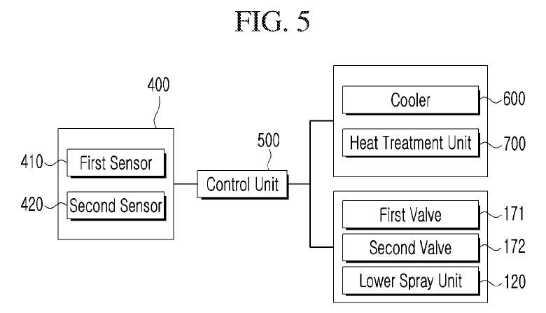

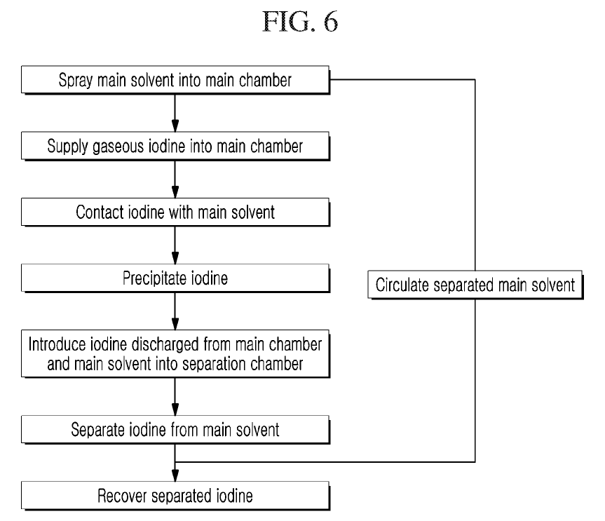

FIG. 4 is a conceptual diagram of an iodine recovery apparatus according to another embodiment of the present disclosure, and FIG. 5 is a block diagram illustrating connection relationships between some components constituting the iodine recovery apparatus according to an embodiment of the present disclosure.

Referring to FIGS. 4 and 5, a lower spray unit 120 may be disposed in the main chamber 100.

The lower spray unit 120 may extend from the upper spray unit 110 and be disposed at the lower portion of the main chamber 100. The main solvent may be sprayed from the lower spray unit 120.

The lower spray unit 120 may spray the main solvent at high pressure. The lower spray unit 120 may spray the main solvent toward the separation chamber 200. By spraying the main solvent at high pressure, the lower spray unit 120 may move the main solvent and the precipitated iodine deposited in the lower portion of the main chamber 100 by the pressure. The main solvent and the precipitated iodine deposited in the lower portion of the main chamber 100 may be discharged from the main chamber 100 by the pressure. The main solvent and the precipitated iodine deposited in the lower portion of the main chamber 100 may be discharged from the main chamber 100 by the lower spray unit 120 and introduced into the separation chamber 200.

A connecting passage 170 may be disposed between the main chamber 100 and the separation chamber 200. One end of the connecting passage 170 may be connected to the main chamber 100, and the other end of the connecting passage 170 may be connected to the separation chamber 200.

A first valve 171 may be disposed between the connecting passage 170 and the main chamber 100. The first valve 171 may be disposed at one end of the connecting passage 170. The first valve 171 may control a movement direction of the main solvent. The first valve 171 may close the connecting passage 170. For example, the first valve 171 may close the connecting passage 170 to prevent the main solvent from being introduced into the main chamber 100 along the connecting passage 170. Alternatively, the first valve 171 may close a portion of the main chamber 100 connected to the connecting passage 170. For example, the first valve 171 may close the connecting passage 170 such that the main solvent moves only in one direction from the main chamber 100 toward the connecting passage 170.

A second valve 172 may be disposed between the connecting passage 170 and the separation chamber 200. The second valve 172 may be disposed at the other end of the connecting passage 170. The second valve 172 may control the movement direction of the main solvent. The second valve 172 may close the connecting passage 170. For example, the second valve 172 may close the connecting passage 170 to prevent the main solvent from flowing out of the separation chamber 200 along the connecting passage 170. Alternatively, the second valve 172 may close a portion of the separation chamber 200 connected to the connecting passage 170. For example, the second valve 172 may close the connecting passage 170 such that the main solvent moves only in one direction from the connecting passage 170 toward the separation chamber 200.

For example, the first valve 171 and the second valve 172 may be valves that open in only one direction. For example, the first and second valves 171 and 172 may be check valves.

Referring to FIG. 5, the first valve 171, the second valve 172, and the lower spray unit 120 may be operatively connected to a control unit 500. For example, the control unit 500 may control operations of the first valve 171, the second valve 172, and the lower spray unit 120.

For example, the lower spray unit 120 may be switched on and off at preset time intervals. For example, the lower spray unit 120 may spray the main solvent for a predetermined period of time. Thereafter, the lower spray unit 120 may cease spraying operation (or closed) for a predetermined period of time. For example, a third valve (not shown) may be disposed at an end portion of the lower spray unit 120. The control unit 500 may control on/off operation of the lower spray unit 120 by controlling the third valve. The control unit 500 may control the operation of the lower spray unit 120.

For example, the lower spray unit 120 may operate for one hour and then stop operating. Of course, any other period of time is also contemplated and within the scope of this disclosure.

When the lower spray unit 120 operates, the first and second valves 171 and 172 may be opened. When the lower spray unit 120 operates, the control unit 500 may control the first and second valves 171 and 172 to open. In this case, due to pressure of the main solvent sprayed from the lower spray unit 120, the main solvent and iodine precipitated in a lower portion of the main chamber 100 may be transferred to the separation chamber 200 along the connecting passage 170.

A time during which the first and second valves 171 and 172 are opened may be the same as an operating time of the lower spray unit 120. A time during which the first and second valves 171 and 172 are closed may be the same as a time during which the lower spray unit 120 stops operating.

Operating times or stop times of the lower spray unit 120, the first valve 171, and the second valve 172 may vary depending on environmental conditions. The separation chamber 200 may be connected to the main chamber 100.

Iodine precipitated in the main chamber 100 may be discharged from the main chamber 100 together with the main solvent and transferred to the separation chamber 200.

The separation chamber 200 may be positioned at one side of the main chamber 100. The separation chamber 200 may be connected to the main chamber 100 and the tray 160. Alternatively, the separation chamber 200 may be connected to the main chamber 100 by a separate member (not shown) extending from the tray 160 or connected to the tray 160.

The precipitated iodine and the main solvent may move along the tray 160, be discharged from the main chamber 100, and be introduced into the separation chamber 200.

In the separation chamber 200, the iodine precipitated in the main chamber 100 may be separated from the main solvent.

The iodine introduced into the separation chamber 200 may be separated from the main solvent to form a layer.

For example, due to a density difference between the precipitated iodine and the main solvent, the precipitated iodine may be positioned at a lower portion of the separation chamber 200, and the main solvent may be positioned above the precipitated iodine.

For example, in the separation chamber, the precipitated iodine and the main solvent may be separated from each other by centrifugation.

For example, a filter (not shown) may be installed in the separation chamber 200. The main solvent introduced into the separation chamber 200 may pass through the filter, while the precipitated iodine may be retained by the filter. The precipitated iodine may thereby be separated from the main solvent by the filter.

For example, the precipitated iodine and the main solvent may be subjected to heat treatment in the separation chamber 200 to be separated from each other.

For example, the iodine recovery apparatus may further include a sensor unit (400), and the sensor unit (400) may include a first sensor (410) and a second sensor (420). For example, a first sensor 410 may be connected to the separation chamber 200. For example, the first sensor 410 may be a temperature sensor. The first sensor 410 may measure a temperature of the main solvent introduced into the separation chamber 200.

After measuring the temperature of the main solvent and the precipitated iodine by the first sensor 410, the control unit 500 may control heating of the main solvent and the precipitated iodine introduced into the separation chamber 200 based on the measured temperature.

For example, the control unit 500 may operate a heat treatment unit 700. The heat treatment unit 700 may heat the separation chamber 200. The heat treatment unit 700 may heat the main solvent contained in the separation chamber 200.

For example, the heat treatment unit 700 may receive a signal from the control unit 500 and heat the separation chamber 200 to approximately 100° C to distill the main solvent. For example, the separation chamber 200 may be heated to approximately 70° C to 130° C. The heat treatment unit 700 may heat and distill the main solvent introduced into the separation chamber 200. As described above, the boiling point of the main solvent may be 100° C or lower. The precipitated iodine may remain in a solid state at 100° C under conditions within a range of 1 atm to 3 atm.

When the separation chamber 200 or the main solvent contained in the separation chamber 200 is heated to 100° C, the main solvent may be distilled, and the precipitated iodine may remain in a solid particle state. Alternatively, the main solvent may be distilled, and the precipitated iodine may be liquefied to undergo a phase change into a liquid state. In this manner, the precipitated iodine may be separated from the main solvent by distillation of the main solvent.

For example, the heat treatment unit 700 may receive a signal from the control unit 500 and heat the separation chamber 200 to 120° C to 150° C. The heat treatment unit 700 may heat the main solvent and the precipitated iodine introduced into the separation chamber 200. In this case, the precipitated iodine may be converted into liquid iodine.

The separation chamber 200 may further include a liquid-liquid separator 180, illustrated in FIG. 1. The main solvent and the liquid iodine may be subjected to liquid-liquid separation utilizing a density difference therebetween, thereby separating the liquid iodine. The liquid iodine may have a higher density than the main solvent. The liquid iodine may coexist with the main solvent without mixing therewith. For example, due to the density difference between the liquid iodine and the main solvent, the liquid iodine may be positioned at a lower portion, while the main solvent may be positioned at an upper portion. Since the liquid iodine does not mix with the main solvent, the liquid iodine may be separated and recovered by liquid-liquid separation.

For example, when the main solvent is distilled in the separation chamber 200, only the precipitated iodine may remain in the separation chamber 200, and the precipitated iodine may be recovered from the separation chamber 200.

The iodine recovery apparatus according to an embodiment may further include a circulation pipe 300 and a cooler 600.

The circulation pipe 300 may connect the separation chamber 200 and the main chamber 100.

The main solvent separated from the precipitated iodine in the separation chamber 200 may be supplied to the main chamber 100 through the circulation pipe 300.

A discharge filter 310 may be installed between the separation chamber 200 and the circulation pipe 300. The main solvent contained in the separation chamber 200 may pass through the discharge filter 310 and be introduced into the circulation pipe 300. The precipitated iodine contained in the separation chamber 200 may be filtered by the discharge filter 310. The precipitated iodine contained in the separation chamber 200 may not be introduced into the circulation pipe 300.

A pump (not shown) may be connected to the circulation pipe 300 to supply the main solvent within the separation chamber 200 to the main chamber 100.

The cooler 600 may be connected to the circulation pipe 300. The cooler 600 may cool the main solvent moving through the circulation pipe 300.

A second sensor 420 may be connected to the circulation pipe 300. For example, the second sensor 420 may be a temperature sensor. The second sensor 420 may measure the temperature of the main solvent moving through the circulation pipe 300. The control unit 500 may receive the temperature of the main solvent from the second sensor 420 and control operation of the cooler 600 based on the measured temperature.

The main solvent supplied into the main chamber 100 through the circulation pipe 300 may be supplied to the main chamber 100 at a reduced temperature by the cooler. The cooled main solvent may contact gaseous iodine in the main chamber 100. The gaseous iodine may be cooled and precipitated upon contact with the main solvent.

For example, the cooler 600 may reduce the temperature of the main solvent supplied to the main chamber 100, from the circulation pipe 300, to 50° C or lower. Operation of the cooler 600 may be controlled by the control unit 500. The control unit 500 may receive the temperature of the main solvent from the second sensor 420 and control operation of the cooler 600 such that the main solvent is cooled.

This is because, due to the characteristics of iodine vapor pressure, when the temperature exceeds 50° C, the iodine vapor pressure may rapidly increase, which may result in iodine loss (I₂ loss).

A gas outlet 150 may be formed at the upper portion of the main chamber 100.

The gas mixture may contact the main solvent, and its composition may partially change. For example, iodine included in the gas mixture may be dissolved in the main solvent upon contact with the main solvent. Gaseous iodine may be liquefied or precipitated upon contact with the main solvent. Components other than iodine included in the gas mixture may also be dissolved, liquefied, or sublimed upon contact with the main solvent.

Some components of the main solvent may also vaporize upon contact with the gas mixture.

After the gas mixture and the main solvent contact each other, the main solvent and the gas mixture may remain within the main chamber 100. The gas mixture remaining in the main chamber 100 may be discharged from the main chamber 100 through the gas outlet 150 formed at the upper portion of the main chamber 100.

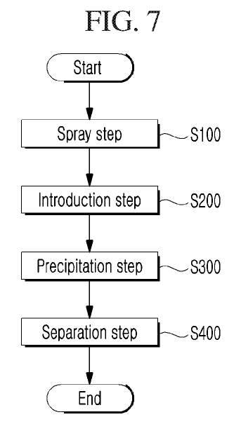

FIG. 6 is a flowchart illustrating an operating sequence of each component of the iodine recovery apparatus according to an embodiment of the present disclosure.

Hereinafter, an iodine recovery process of the iodine recovery apparatus according to an embodiment of the present disclosure will be described with reference to FIG. 6.

The upper spray unit 110 may be disposed in an upper portion of the main chamber 100. The upper spray unit 110 may spray the main solvent downward from the upper portion of the main chamber 100. The temperature of the main solvent sprayed into the main chamber 100 may be 50° C or lower.

The inlet pipe 130 may be installed on one side of the main chamber 100. The inlet pipe 130 may be positioned below the upper spray unit 110. A gas mixture including gaseous iodine may be introduced into the main chamber 100 through the inlet pipe 130.

The gas mixture may be introduced into the main chamber 100 and may come into contact with the main solvent. The gas mixture may be heated to 150° C to 250° C before being introduced into the main chamber 100. For example, the gas mixture may be heated and introduced into the inlet pipe 130. For example, the inlet pipe 130 may be heated to increase the temperature of the gas mixture.

The gas mixture may be introduced into the main chamber 100 and may contact the falling main solvent. The gas mixture may be dispersed by the dispersion plate 140 within the main chamber 100. The dispersed gas mixture may contact the falling main solvent and be cooled. Gaseous iodine may be cooled upon contact with the main solvent and may be precipitated.

The precipitated iodine and the main solvent may move along the tray 160. The tray 160 may have the through holes 161 formed therethrough. The gas mixture may pass through the through holes 161, move upward, and come into contact with the main solvent.

A plurality of trays 160 may be provided along the vertical direction of the main chamber 100. The precipitated iodine and the main solvent may pass through the through holes 161 and move downward. Some of the precipitated iodine may move along the tray 160 due to a flow of the main solvent and be introduced into the separation chamber 200. Some of the precipitated iodine may pass through the through holes 161 and move downward.

The lower spray unit 120 may be disposed at the lower portion of the main chamber 100. The lower spray unit 120 may extend from the upper spray unit 110. The lower spray unit 120 may spray the main solvent at high pressure. The lower spray unit 120 may spray the main solvent toward the separation chamber 200. By spraying the main solvent at high pressure, the lower spray unit 120 may discharge the main solvent and the precipitated iodine deposited in the lower portion of the main chamber 100 from the main chamber 100.

The separation chamber 200 may be connected to the main chamber 100.

For example, the tray 160 may extend from the main chamber 100 and be connected to the separation chamber 200.

The precipitated iodine and the main solvent discharged from the main chamber 100 may be introduced into the separation chamber 200. For example, the precipitated iodine and the main solvent may move along the tray 160.

For example, the tray 160 may be installed in the main chamber 100 so as to be inclined downward toward the separation chamber 200. The main solvent remaining on the upper surface of the tray 160 may move along the inclined surface of the tray 160 by gravity. The precipitated iodine remaining on the upper surface of the tray 160 may be dispersed in the main solvent and move together with the main solvent.

In the separation chamber 200, the precipitated iodine and the main solvent may be separated.

For example, a filter may be installed in the separation chamber 200. The main solvent may pass through the filter, and the precipitated iodine may be retained by the filter, thereby separating the precipitated iodine from the main solvent. For example, the precipitated iodine and the main solvent may be separated from each other by centrifugation.

For example, in the separation chamber 200, the main solvent and the precipitated iodine may be subjected to heat treatment to be separated from each other.

For example, the first sensor 410 may be connected to the separation chamber 200. The first sensor 410 may measure the temperature of the main solvent within the separation chamber 200.

The control unit 500 may operate the heat treatment unit 700 to distill the main solvent contained in the separation chamber 200. By distilling the main solvent, the main solvent and the precipitated iodine may be separated.

The control unit 500 may operate the heat treatment unit 700 to heat the main solvent and the precipitated iodine contained in the separation chamber 200. The precipitated iodine may be converted into liquid iodine. By utilizing a density difference between the main solvent and the liquid iodine, the main solvent and the liquid iodine may be separated. For example, the main solvent and the liquid iodine may be separated from each other by performing liquid-liquid separation.

The iodine separated from the main solvent in the separation chamber 200 may be transferred from the separation chamber 200 to a recovery chamber. Alternatively, the iodine separated from the main solvent in the separation chamber 200 may be recovered in the separation chamber 200.

The main solvent separated from the iodine in the separation chamber 200 may move through the circulation pipe 300 and be supplied to the main chamber 100.

The main solvent may be transferred from the main chamber 100 to the separation chamber 200 and then be supplied back to the main chamber 100. For example, the main solvent may be circulated from the main chamber 100 through the separation chamber 200 and back to the main chamber 100.

The main solvent may be circulated while being cooled by the cooler 600.

The second sensor 420 may be connected to the circulation pipe 300. For example, the second sensor 420 may be a temperature sensor. The second sensor 420 may measure the temperature of the main solvent moving through the circulation pipe 300. The control unit 500 may receive the temperature of the main solvent moving through the circulation pipe 300 from the second sensor 420. The control unit 500 may operate the cooler such that the temperature of the main solvent is cooled to 50° C or lower. The cooler may reduce the temperature of the main solvent supplied to the main chamber 100 to 50° C or lower. The main solvent may be cooled to 50° C or lower and supplied to the main chamber 100.

A gas mixture including gaseous iodine may be continuously supplied to the main chamber 100. The main solvent may be cooled and circulated to the main chamber 100 through the circulation pipe 300. The gas mixture may come into contact with the circulating main solvent. The gaseous iodine may be cooled and precipitated upon contact with the main solvent. The precipitated iodine may be separated from the main solvent in the separation chamber 200, such that iodine may be continuously recovered.

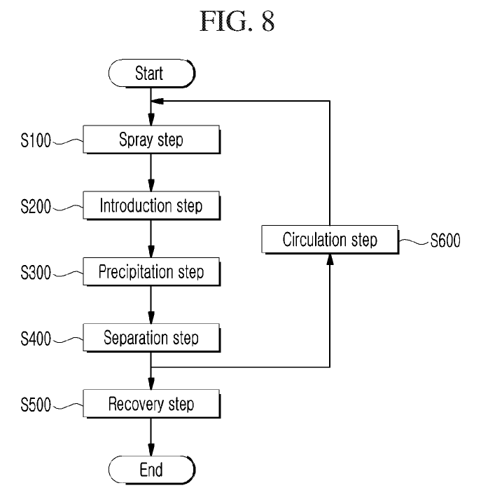

FIGS. 7 and 8 are flowcharts illustrating an iodine recovery method according to an embodiment of the present disclosure. Hereinafter, the iodine recovery method according to an embodiment will be described with reference to FIGS. 7 and 8. Duplicate descriptions of the iodine recovery apparatus according to an embodiment will be omitted.

The iodine recovery method according to an embodiment may include a spray step (S100), an introduction step (S200), a precipitation step (S300), and a separation step (S400).

In the spray step (S100), the main solvent may be sprayed from the upper spray unit 110 disposed in the upper portion of the main chamber 100. The main solvent may be sprayed downward from the upper portion of the main chamber 100.

In the introduction step (S200), gaseous iodine may be introduced into the main chamber 100. A gas mixture including gaseous iodine may be introduced into the main chamber 100 through the inlet pipe 130. The inlet pipe 130 may be connected to the main chamber 100 below the upper spray unit 110. The inlet pipe 130 may be positioned approximately below a longitudinal central portion of the main chamber 100.

The dispersion plate 140 may be disposed within the main chamber 100. The dispersion plate 140 may be disposed above the inlet pipe 130. A gas mixture introduced into the main chamber 100 through the inlet pipe 130 may be dispersed within the main chamber 100 after passing through the dispersion plate 140.

In the precipitation step (S300), a gas mixture including iodine may come into contact with the main solvent. The gaseous iodine may be cooled upon contact with the main solvent and precipitated as solid iodine. For example, the temperature of the main solvent dispersed within the main chamber 100 may be 50° C or lower. The temperature of the gas mixture introduced into the main chamber 100 through the inlet pipe 130 may be 150° C to 250° C. The high-temperature gaseous iodine may be cooled upon contact with the low-temperature main solvent. The gaseous iodine may be precipitated as solid iodine.

The precipitated iodine and the main solvent may be discharged from the main chamber 100 and introduced into the separation chamber 200.

The discharged iodine and the main solvent may move along the tray 160 installed in the main chamber 100. The tray 160 may be installed within the main chamber 100 so as to be inclined downward toward the separation chamber 200.

In the separation step (S400), the precipitated iodine and the main solvent moved into the separation chamber 200 may be separated. For example, as described above, the filter may be installed in the separation chamber 200. Alternatively, centrifugation may be performed to separate the precipitated iodine from the main solvent. Alternatively, the heat treatment unit 700 may heat-treat the separation chamber 200 or the main solvent to separate the precipitated iodine from the main solvent. Since the method for separating the precipitated iodine and the main solvent has been described above, a detailed description thereof will be omitted.

Referring to FIG. 8, the iodine recovery method according to an embodiment of the present disclosure may further include a recovery step (S500) and a circulation step (S600) after the separation step (S400).

In the recovery step (S500), iodine separated from the main solvent in the separation chamber 200 may be recovered. For example, the iodine separated from the main solvent and remaining in the separation chamber 200 may be recovered. Alternatively, the iodine separated from the main solvent may be transferred to the recovery chamber and be recovered.

For example, the liquid iodine separated from the main solvent may be recovered. The iodine contained in the separation chamber 200 may be recovered. Alternatively, the iodine may be transferred to the recovery chamber and recovered therein.

In the circulation step (S600), the main solvent separated from the iodine precipitated in the separation step (S400) may be supplied to the main chamber 100. The circulation pipe 300 may connect the main chamber 100 and the separation chamber 200. The main solvent may be transferred from the separation chamber 200 to the main chamber 100 through the circulation pipe 300 and be circulated.

As described above, the cooler 600 may be connected to the circulation pipe 300. The main solvent discharged from the separation chamber 200 may be cooled by the cooler 600 and supplied to the main chamber 100.

While the preferred embodiments of the present invention have been described in detail above, the scope of the present disclosure is not limited thereto. Various modifications and improvements made by those skilled in the art, utilizing the basic concepts of the present disclosure also fall within the scope of the present disclosure.

What is claimed is:

1. An iodine recovery apparatus comprising:
a main chamber configured to bring gaseous iodine into contact with a main solvent so that the gaseous iodine is cooled and precipitated;
an upper spray unit disposed in an upper portion of the main chamber, the upper spray unit being connected to receive the main solvent, the upper spray unit having spray holes configured to spray the main solvent downward from the upper portion;
an inlet pipe positioned below the upper spray unit and connected to the main chamber, the inlet pipe is configured to introduce the gaseous iodine into the main chamber; and
a separation chamber configured to receive iodine precipitated in the main chamber and the main solvent from the main chamber, and to separate the precipitated iodine and the main solvent.

2. The iodine recovery apparatus according to claim 1, further comprising a dispersion plate disposed within the main chamber, the dispersion plate being configured to disperse the gaseous iodine.

3. The iodine recovery apparatus according to claim 1, further comprising at least one tray disposed below the upper spray unit, the at least one tray being configured to guide movement of the main solvent and the precipitated iodine.

4. The iodine recovery apparatus according to claim 3, wherein the at least one tray is inclined downward toward the separation chamber.

5. The iodine recovery apparatus according to claim 3, wherein the at least one tray comprises a plurality of trays that are provided along a vertical direction of the main chamber.

6. The iodine recovery apparatus according to claim 5, wherein the plurality of trays are each connected to the separation chamber, the plurality of trays being configured to transfer the main solvent and the precipitated iodine on each of the plurality of trays to the separation chamber.

7. The iodine recovery apparatus according to claim 3, wherein the at least one tray has through holes configured to allow passage of the gaseous iodine or the precipitated iodine therethrough.

8. The iodine recovery apparatus according to claim 3, wherein the at least one tray is coated with any one of a polytetrafluoroethylene (PTFE) film, a polyethylene terephthalate (PET) film, and a tetrafluoroethylene-perfluoroalkyl vinyl ether copolymer (PFA) film.

9. The iodine recovery apparatus according to claim 1, wherein the iodine recovery apparatus is further configured to separate the precipitated iodine from the main solvent.

10. The iodine recovery apparatus according to claim 1, further comprising a filter disposed in the separation chamber, the filter being configured to allow the main solvent to pass therethrough and prevent the precipitated iodine from passing therethrough.

11. The iodine recovery apparatus according to claim 1, further comprising a heat treatment unit in the separation chamber configured to heat the precipitated iodine and the main solvent, thereby separating the precipitated iodine and the main solvent.

12. The iodine recovery apparatus according to claim 11, wherein the heat treatment unit is configured to perform the separating by distilling the main solvent in the separation chamber.

13. The iodine recovery apparatus according to claim 11, wherein the heat treatment unit is configured to heat the main solvent and the precipitated iodine in the separation chamber such that the precipitated iodine is converted into liquid iodine, and
wherein the separation chamber further comprises a liquid-liquid separator configured to receive the main solvent and the liquid iodine and subject the main solvent and the liquid iodine to liquid-liquid separation, thereby recovering the liquid iodine.

14. The iodine recovery apparatus according to claim 1, further comprising a circulation pipe connected to the main chamber and the separation chamber, the circulation pipe being configured to supply the main solvent separated from the precipitated iodine in the separation chamber to the main chamber.

15. The iodine recovery apparatus according to claim 14, further comprising a cooler connected to the circulation pipe, the cooler being configured to cool the main solvent supplied to the main chamber.

16. The iodine recovery apparatus according to claim 1, further comprising a lower spray unit extending from the upper spray unit, the lower spray unit being disposed at a lower portion of the main chamber,
wherein the lower spray unit is configured to spray the main solvent toward the separation chamber.

17. An iodine recovery method comprising:
spraying a main solvent downward from an upper spray unit disposed in an upper portion of a main chamber;
introducing gaseous iodine into the main chamber;
cooling the gaseous iodine upon contact with the main solvent in the main chamber to precipitate the iodine; and
separating the precipitated iodine from the main solvent.

18. The iodine recovery method according to claim 17, wherein the main chamber comprises a tray configured to guide movement of the main solvent and the precipitated iodine as part of the introducing the precipitated iodine and the main solvent into a separation chamber.

19. The iodine recovery method according to claim 17, further comprising supplying the main solvent separated in a separation chamber to the main chamber.

20. The iodine recovery method according to claim 19, wherein the supplying the main solvent separated in the separation chamber to the main chamber further comprises cooling the main solvent before the main solvent is supplied to the main chamber.
